(19) United States
(12) Patent Application Publication
(10) Pub. No.: US 2021/0130612 A1
(43) Pub. Date: May 6, 2021

(54) COMPOSITION CONTAINING POLYAMIDE FOR COOLANT PIPES

(71) Applicant: Arkema France, Colombes (FR)

(72) Inventors: Philippe Blondel, Bernay (FR); Thierry Briffaud, Bernay (FR)

(21) Appl. No.: 16/616,992

(22) PCT Filed: May 31, 2018
(86) PCT No.: PCT/EP2018/064326

§ 371 Date: Nov. 26, 2019

(30) Foreign Application Priority Data
Jun. 2, 2017 (FR) 1754922

(51) Int. Cl. C08L 77/08; F16L 11/06; C08G 69/14; C08G 69/36; C08L 23/08; C08L 51/06; C08K 5/00

(52) U.S. Cl. CPC C08L 77/08; F16L 11/06; C08G 69/14; C08L 2203/18; C08L 23/08; C08L 51/06; C08K 5/0016; C08G 69/36

(57) ABSTRACT

The invention relates to the use of a composition comprising at least one polyamide, at least one of said polyamides being a semi-crystalline copolyamide comprising at least one minority monomer unit resulting from the polycondensation of at least one diamine with at least one polymerised fatty acid, particularly a fatty acid dimer, or at least one diamine dimer with at least one dicarboxylic acid, or at least one amino acid dimer, or the mixtures thereof, as a sealing layer in a pipe containing a cooling liquid.

The present invention relates to the use of a composition comprising at least one semi-crystalline copolyamide comprising at least one minority monomer unit from in particular the polycondensation of at least one diamine with a fatty acid dimer, as a sealing layer in a pipe, particularly a flexible pipe, containing a cooling liquid.

The invention also relates to structures or pipes obtained from said compositions.

In the automotive field, and in particular in the cooling sector, materials are sought after that resist high temperature, i.e. a temperature greater than 130° C. Indeed, automotive constructors build more and more confined motors, in and around which the temperature of the ambient air is higher and higher.

The temperature of the air surrounding the engine is rising for reasons of yield and noise.

This is in particular the case for common-ramp direct-injection diesel engines. In the case of thermoplastic tubes containing polyamide carrying the cooling liquid, the outer surface is in contact with hot air and the inner surface in contact with aggressive liquids. The higher external temperature will tend to increase the temperature of the liquid, making it even more aggressive for the tube's thermoplastic material. Resistance to aging against liquids, such as the cooling liquid, must therefore be improved. These liquids, under the effect of higher temperatures, are particularly sensitive to oxidation and degradation. This typically results in the formation of peroxides, which decompose into free radicals, which themselves attack the polymer material of the automobile part in contact with said liquid.

These preoccupations target in particular, in a non-limiting manner, structures having the form of tubes used for the circulation of aggressive liquids, such as cooling liquids, brake liquids, parts located near the engine or also structures such as reservoirs.

To improve resistance to thermal aging of such structures, these are generally made from compositions comprising a polymer, classically a polyamide, various additives like a plasticizer, shock modifier and a stabilizer.

Accordingly, it would be interesting to find a resistant material having excellent resistance to aging in contact with aggressive fluids.

Document US 2008/0038499 describes a composition comprising a specific semi-aromatic copolyamide and a polyolefin for the production of water tubes intended for automobiles.

Patent FR 1 395 076 describes compositions containing dimerized fatty acids with low water absorption. The compositions exemplified contain a very high molar fraction of dimerized fatty acids.

Neither resistance to hydrolysis, nor the cooling application, are mentioned.

International applications WO 2006/047775 and WO 2007/044573 both describe copolyamide compositions resistant to hydrolysis containing minority co-monomers containing an aromatic or alicyclic ring. However, these compositions do not significantly improve the resistance to hydrolysis of PA11.

International application WO2008104719 describes compositions A/(Cz diamine).(Cw diacid) wherein Cw may be a fatty acid dimer. These products are used as adhesives and neither resistance to hydrolysis, nor the cooling application, are mentioned.

Patent FR3010408 describes copolyamides containing fatty acid dimers. This patent claims a use for sport articles but the cooling application is not mentioned.

The compositions used today lead to lifetimes of around 400 hours. Therefore, these parts must be changed regularly. Multilayer tubes also exist formed of a layer that is a barrier to fluids on the inside, generally containing fluorinated polymers, and a heat-resistant layer on the outside. These structures have a much longer lifetime, but the use of fluorinated material is extremely expensive and these are materials that are difficult to transform.

Accordingly, a real need exists to find new compositions that can make parts having simultaneously improved strength at high temperature on the outside, such as for example between 130 to 175° C. and improved resistance to aggressive liquids on the inside, in particular at high temperatures, such as 80 or 130° C., while retaining a reasonable production cost.

A first subject of the invention is therefore the use of a composition comprising at least one semi-crystalline copolyamide comprising at least one minority monomer unit from in particular the polycondensation of at least one diamine with a fatty acid dimer, as a sealing layer in a pipe, particularly a flexible pipe, containing a cooling liquid.

A second subject of the invention relates to structures or pipes obtained from said compositions.

Use

The present invention relates to the use of a composition comprising at least one polyamide, of which at least one of said polyamides is a semi-crystalline copolyamide comprising at least one minority monomer unit coming from the polycondensation:
of at least one diamine with at least one polymerized fatty acid, particularly a fatty acid dimer, or
of at least one diamine dimer with at least one dicarboxylic acid, or
of at least one amino acid dimer,

particularly coming from the polycondensation:
of at least one diamine with at least one polymerized fatty acid, particularly a fatty acid dimer, or
of at least one diamine dimer with at least one dicarboxylic acid,

or mixtures thereof,

as a sealing layer in a pipe, particularly a flexible pipe, containing a cooling liquid.

The Inventors have found in a completely unexpected manner that the use of a semi-crystalline copolyamide comprising at least one minority monomer unit containing a polymerized fatty acid or a diamine dimer or an amino acid dimer would produce compositions that have good extrusion properties, better heat-resistance and improved pipe service temperature and therefore better resistance to hydrolysis.

In the entire description, unless otherwise indicated, all the percentages indicated are percentages by weight.

The expression “composition comprising at least one polyamide, of which at least one is a semi-crystalline copolyamide comprising at least one minority monomer unit . . . ” means that the composition must comprise:
a single polyamide, and in this case, said polyamide may only be the semi-crystalline copolyamide comprising at least one minority monomer unit,
two polyamides, and in this case, one of the polyamides is the semi-crystalline copolyamide comprising at least one minority monomer unit and the other may be any other polyamide, i.e. a semi-crystalline or amorphous polyamide, homopolyamide or copolyamide, or both polyamides are different semi-crystalline copolyamides and comprising at least one minority monomer unit,
three polyamides, and in this case, one of the polyamides is the semi-crystalline copolyamide comprising at least one minority monomer unit and two others may be any other polyamide, i.e. a semi-crystalline or amorphous polyamide, homopolyamide or copolyamide, or two of the polyamides each correspond to a different semi-crystalline copolyamide and each comprise at least one minority monomer unit, and the third polyamide corresponds to any other polyamide, i.e. a semi-crystalline or amorphous polyamide, homopolyamide or copolyamide,
more than three polyamides, and in this case, the additional polyamide(s), relative to the previous possibility with three polyamides, is (are) chosen from a semi-crystalline copolyamide, different from the other semi-crystalline copolyamide(s) and comprising at least one minority monomer unit, and another polyamide, i.e. a semi-crystalline or amorphous polyamide, homopolyamide or copolyamide different from any of the others.

Semi-Crystalline Copolyamide

The expression “semi-crystalline copolyamide” covers copolyamides that have both a glass transition temperature Tg and melting temperature Tm. The Tg and the Tm can be determined according to ISO standards 11357-2:2013 and 11357-3:2013 respectively.

The nomenclature used to define the polyamides is described in ISO standard 1874-1:1992 “Plastiques—Materiaux polyamides (PA) pour moulage and extrusion—Partie 1: Designation”, in particular on page 3 (Tables 1 and 2) and is well known to the person skilled in the art.

A semi-crystalline copolyamide, in the sense of the invention, denotes a copolyamide that has a melting temperature (Tm) by DSC according to ISO standard 11357-3 of 2013, and a crystallization enthalpy during the cooling step at a rate of 20 K/min by DSC measured according to ISO standard 11357-3 of 2013 greater than 30 J/g, preferably greater than 40 J/g.

The semi-crystalline copolyamide comprises a minority monomer unit that may come from the polycondensation of at least one diamine with at least one polymerized fatty acid, particularly a fatty acid dimer.

Consequently said copolyamide has structure A/X-polymerized fatty acid wherein A is a monomer unit that results from the condensation:
of a C₆ to C12 lactam,
of an alpha,omega-amino C₆ to C12 aliphatic carboxylic acid,
of a Ca diamine and a Cb diacid.

Advantageously, said lactam is C₆ to C11 and said alpha,omega-amino C₆ to C11 aliphatic carboxylic acid.

When polyamide A is a monomer unit having the formula (Ca diamine).(Cb diacid) Ca and Cb denote the number of carbon atoms in the diamine and the diacid respectively, the monomer unit (Ca diamine) is chosen from the aliphatic, linear or branched diamines, cycloaliphatic diamines and alkylaromatic diamines.

When the Ca diamine is aliphatic and linear, having formula H2N—(CH2)a-NH2, the monomer (Ca diamine) is preferably chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22).

Advantageously, when the Ca diamine is aliphatic and linear, it is chosen from butanediamine (a=4), pentanediamine (a=5), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22).

When the diamine is aliphatic and branched, it may include one or more methyl or ethyl substituents on the main chain. For example, the monomer (Ca diamine) may advantageously be chosen from 2,2,4-trimethyl-1,6-hexanediamine, 2,4,4-trimethyl-1,6-hexanediamine, 1,3-diaminopentane, 2-methyl-1,5-pentanediamine, 2-methyl-1,8-octanediamine.

When the monomer (Ca diamine) is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclo-hexyl)propane,bis(3,5-dialkyl-4-aminocyclo-hexyl)butane,bis-(3-methyl-4-aminocyclohexyl)-methane (BMACM or MACM), p-bis(aminocyclohexyl)-methane (PACM) and isopropylidenedi(cyclohexylamine) (PACP), isophoronediamine (a=10), piperazine (a=4), amino-ethylpiperazine. It may also include the following carbon backbones: norbornyl methane, cyclohexylmethane, dicyclohexylpropane, di(methylcyclohexyl), di(methylcyclohexyl) propane. A non-exhaustive list of these cycloaliphatic diamines is given in the publication “Cycloaliphatic Amines” (Encyclopaedia of Chemical Technology, Kirk-Othmer, 4th Edition (1992), pp. 386-405).

When the monomer (Ca diamine) is alkylaromatic, it is chosen from 1,3-xylylene diamine and 1,4-xylylene diamine.

The monomer unit (Cb diacid) is chosen from linear or branched aliphatic diacids, cycloaliphatic diacids, aromatic diacids.

In the entire description, the expressions “diacid” and “dicarboxylic acid” and “carboxylic diacid” denote the same product.

When the monomer (Cb diacid) is aliphatic and linear, it is chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanoic acid (b=18), octadecenedioic acid (b=18), eicosanedioic acid (b=20), docosanedioic acid (b=22).

When the diacid is cycloaliphatic, it can include the following carbon backbones: norbornyl, cyclohexyl, dicyclohexyl, dicyclohexyl, dicyclohexylpropane.

When the diacid is aromatic, it is chosen from terephthalic acid (denoted T), isophthalic acid (denoted I) and naphthalenic diacids.

X is a diamine as defined above for Ca diamine and when diamine X in Ca is aliphatic and linear, it is chosen from butanediamine (a=4), pentanediamine (a=5), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22).

In another embodiment, when diamine X in Ca is aliphatic and linear, it is chosen from heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22).

Advantageously, when diamine X in Ca is aliphatic and linear, it is chosen from nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22). Polymerized fatty acids denote the compounds produced from coupling reactions of unsaturated fatty acids that lead to mixtures of products bearing two acid functions (called acid dimers) or three acid functions (called acid trimers).

The polymerized fatty acids are sold and in particular the product with trade name Pripol® sold by Croda can be used as well as the product with trade name Empol® sold by Cognis or the product with trade name Unydime® sold by Arizona Chemical or also the product with trade name Radiacid® sold by Oleon.

After separation, the fatty acid dimers are obtained mainly from 75% to more than 98%, in a mixture with in particular the corresponding monomer, 1½ mer and trimer.

The fatty acid dimers may then be transformed into amine dimers (by the transformation of the two acid functions into amine functions) or into amino acid dimers (by the transformation of one of the acid functions into an amine function.

The semi-crystalline copolyamide comprises a minority monomer unit that may also come from the polycondensation of at least one diamine dimer with at least one dicarboxylic acid.

Consequently said copolyamide has structure A/diamine dimer-Y wherein A is as defined above. The diamine dimer comes from a fatty acid dimer in which the acid functions have been transformed into amine functions.

Y represents a dicarboxylic acid as defined for the Cb diacid.

The semi-crystalline copolyamide comprises a minority monomer unit that may come from the polycondensation of at least one amino acid dimer.

Consequently said copolyamide has structure A/amino acid dimer wherein A is as defined above. The amino acid dimer comes from a fatty acid dimer in which one of the acid functions has been transformed into an amine function.

The composition of the invention is used as a sealing layer in a pipe, particularly a flexible pipe, containing a cooling liquid.

These pipes serve to carry a cooling liquid, such as a solution containing alcohol, particularly ethylene glycol and/or water that can be used in the cooling circuit of engines)

The pipe of the invention is not a hydraulic pipe transporting oil, in particular mineral oil.

Advantageously, when the composition comprises two or more polyamides, said semi-crystalline copolyamide (or all of the copolyamides) comprising at least one minority monomer unit is a majority by weight relative to the other polyamide.

In another embodiment, the present invention relates to the use of a composition as defined above, wherein:
said minority monomer unit comprises at least one of the following formulas:
   either the remaining parts of a fatty acid dimer having the following formula (I):

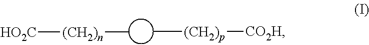

or the remaining parts of a diamine dimer having the following formula (II):

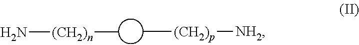

or the remaining parts of an amino acid dimer having the following formula (III):

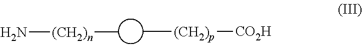

or a mixture thereof,
wherein, independently of each other:
n is comprised from 1 to 10, particularly 1 to 7,
p is comprised from 1 to 10, particularly 1 to 7,

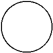

corresponds to a structure chosen from:

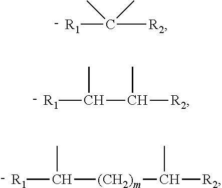

m being comprised from 1 to 5,
   wherein R₁ and R₂ represent, independently of each other, H or a C₁ to C12 alkyl chain,
   particularly C₇ to C₁₁,
and

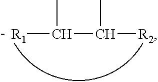

wherein R₁ and R₂ are cyclized to form a structure:
i) with a ring of type
cyclohexane:

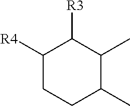

or phenyl:

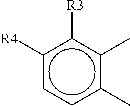

ii) with two rings of 1,2,3,4-tetrahydronaphthalene type

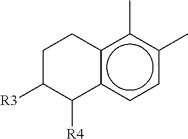

or of bicyclo[4.4.0]decane type:

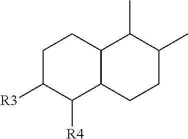

R₃ and R₄ being in the structures of one or two rings of C1 to C10 alkyl residues, particularly C7 to C9,
or a mixture thereof,
the total number of carbon atoms in the diacid having formula (I), the diamine having formula (II) and the amino acid having formula (III) being greater than or equal to 30, particularly greater than or equal to 36, particularly 36.

Advantageously, n is comprised from 5 to 7.

Advantageously, p is comprised from 5 to 7.

Advantageously, n and p are comprised from 5 to 7.

In an advantageous embodiment, the present invention relates to the use of a composition as defined above, wherein:
said polyamide is constituted of a semi-crystalline copolyamide, and
said minority monomer unit comprises at least one of the following formulas:
   either the remaining parts of a fatty acid dimer having the following formula (I):

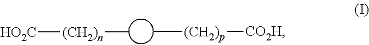

or the remaining parts of a diamine dimer having the following formula (II):

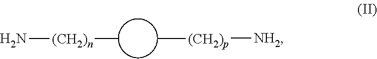

or the remaining parts of an amino acid dimer having the following formula (III):

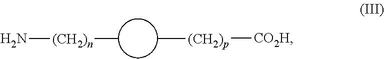

or a mixture thereof,
wherein, independently of each other:
n is comprised from 1 to 10, particularly 1 to 7,
p is comprised from 1 to 10, particularly 1 to 7,

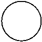

corresponds to a structure chosen from:

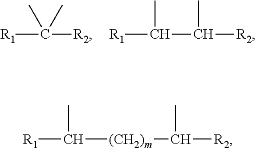

m being comprised from 1 to 5,
   wherein R₁ and R₂ represent, independently of each other, H or a C₁ to C12 alkyl chain,
   particularly C₇ to C₁₁,
   and

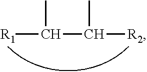

wherein R₁ and R₂ are cyclized to form a structure:
i) with a ring of type
cyclohexane:

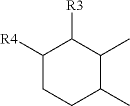

or phenyl:

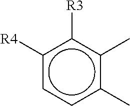

ii) with two rings of 1,2,3,4-tetrahydronaphthalene type:

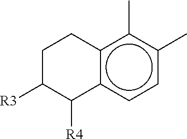

or of bicyclo[4.4.0]decane type:

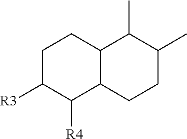

R₃ and R₄ being in the structures of one or two rings of C1 to C10 alkyl residues, particularly C7 to C9,
or a mixture thereof,
the total number of carbon atoms in the diacid having formula (I), the diamine having formula (II) and the amino acid having formula (III) being greater than or equal to 30, particularly greater than or equal to 36, particularly 36.

In an advantageous embodiment, the present invention relates to the use of a composition as defined above, wherein:
said polyamide is constituted of a semi-crystalline copolyamide, and
said minority monomer unit comprises the remaining parts of a fatty acid dimer having the following formula (I):

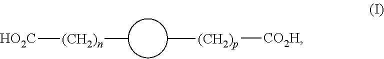

wherein formula (I):
n is comprised from 1 to 10, particularly 1 to 7,
p is comprised from 1 to 10, particularly 1 to 7,

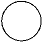

corresponds to a structure chosen from:

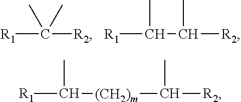

m being comprised from 1 to 5,
   wherein R₁ and R₂ represent, independently of each other, H or a C₁ to C₁₂ alkyl chain, particularly C₇ to C₁₁, and

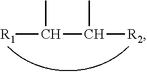

wherein R₁ and R₂ are cyclized to form a structure:
i) with a ring of type
cyclohexane:

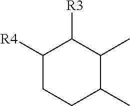

or phenyl:

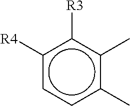

ii) with two rings of 1,2,3,4-tetrahydronaphthalene type

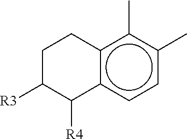

or of bicyclo[4.4.0]decane type:

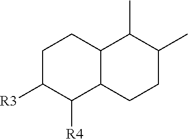

R₃ and R₄ being in the structures of one or two rings of C1 to C10 alkyl residues, particularly C7 to C9,
or a mixture thereof,
   the total number of carbon atoms in the diacid having formula (I) being greater than or equal to 30, particularly greater than or equal to 36, particularly 36.

In an advantageous embodiment, the present invention relates to the use of a composition as defined above, wherein the pipe is a flexible pipe.

In an advantageous embodiment, the present invention relates to the use of a composition as defined above, wherein the copolyamide is an aliphatic copolyamide.

The inventors have found in an unexpected manner that the presence of long lateral aliphatic chains grafted onto the main chain delays the moment when hydrolytic degradation makes the PA fragile and brittle.

The importance of grafting lateral chains onto the main chain must be noted. Indeed, the grafting of a lateral chain onto the nitrogen of amino acid, lactam and diamine monomers leads to a composition having high sensitivity to hydrolysis.

In an advantageous embodiment, the present invention relates to the use of a composition as defined above, wherein the viscosity in solution of the composition, as determined according to ISO standard 307:2007 in m-cresol at a temperature of 20° C., is greater than 1, particularly greater than 1.2.

Advantageously, the polyamide of said composition whose viscosity is greater than 1, particularly greater than 1.2, has an equilibrium content at the ends of the NH2 and COOH chains (the difference between these two functions will preferably be less than 20 μeq/g in excess of NH2 or of COOH as determined by potentiometry.

In an advantageous embodiment, the present invention relates to the use of a composition as defined above, wherein the Tm of the composition is greater than 170° C., as determined according to ISO standard 11357-3:2013 at a rate of 20 K/min in DSC.

In an advantageous embodiment, the present invention relates to the use of a composition as defined above, wherein at least one of the other monomer units of said copolyamide is a monomer unit A chosen from a monomer unit obtained from a C₆ to C₁₂ amino acid, a monomer unit obtained from a C₆ to C₁₂ lactam, and a monomer unit having the formula (Ca aliphatic diamine).(Cb aliphatic diacid), with a representing the number of carbon atoms of the diamine and b representing the number of carbon atoms of the diacid, a and b each being inclusively between 4 and 36, in particular between 4 and 22.

Advantageously, the molar proportion of said at least minority monomer unit in the semi-crystalline copolyamide is greater than or equal to 1%.

Advantageously, the molar proportion of said at least minority monomer unit in the semi-crystalline copolyamide is less than or equal to 20%.

Advantageously, the molar proportion of said at least minority monomer unit in the semi-crystalline copolyamide is from 1 to 20%, particularly from 1 to 10%, in particular from 2 to 10% relative to the sum of all the monomer units of said copolyamide.

A minority monomer unit content greater than 20% is accompanied by a lowered melting point and crystallinity that may be detrimental to the target application.

A minority monomer unit content below 1% does not produce an improvement of the resistance to hydrolysis.

In an advantageous embodiment, the present invention relates to the use of a composition as defined above, wherein:
said polyamide is constituted of a semi-crystalline copolyamide, and
said minority monomer unit, in molar proportion in the semi-crystalline copolyamide comprised from 1 to 20%, particularly from 1 to 10%, in particular from 2 to 10% relative to the sum of all the monomer units of said copolyamide, comprises at least one of the following formulas:
   either the remaining parts of a fatty acid dimer having the following formula (I):

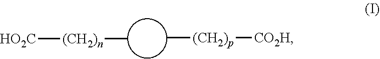

or the remaining parts of a diamine dimer having the following formula (II):

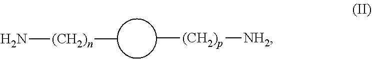

or the remaining parts of an amino acid dimer having the following formula (III):

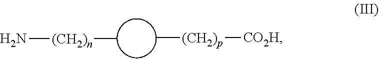

or a mixture thereof,
wherein, independently of each other:
n is comprised from 1 to 10, particularly 1 to 7,
p is comprised from 1 to 10, particularly 1 to 7,

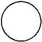

corresponds to a structure chosen from:

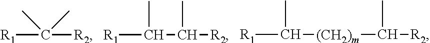

m being comprised from 1 to 5,
   wherein R₁ and R₂ represent, independently of each other, H or a C₁ to C₁₂ alkyl chain, particularly C₇ to C₁₁,
and

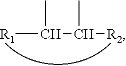

wherein R₁ and R₂ are cyclized to form a structure:
i) with a ring of type
cyclohexane:

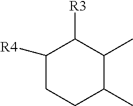

or phenyl:

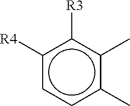

ii) with two rings of 1,2,3,4-tetrahydronaphthalene type

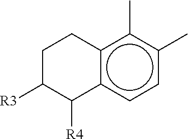

or of bicyclo[4.4.0]decane type:

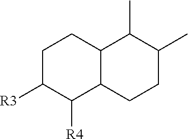

R₃ and R₄ being in the structures of one or two rings of C₁ to C₁₀ alkyl residues, particularly C₇ to C₉,
or a mixture thereof,
the total number of carbon atoms in the diacid having formula (I), the diamine having formula (II) and the amino acid having formula (III) being greater than or equal to 30, particularly greater than or equal to 36, particularly 36,
and at least one of the other monomer units of said copolyamide is a monomer unit A chosen from a monomer unit obtained from a C₆ to C₁₂ amino acid, a monomer unit obtained from a C₆ to C₁₂ lactam, and a monomer unit having the formula (Ca aliphatic diamine).(Cb aliphatic diacid), with a representing the number of carbon atoms in the diamine and b representing the number of carbon atoms in the diacid, a and b each being inclusively between 4 and 36, in particular between 4 and 22.

In an advantageous embodiment, the present invention relates to the use of a composition as defined above, wherein:
said polyamide is constituted of a semi-crystalline copolyamide, and
said minority monomer unit, in molar proportion in the semi-crystalline copolyamide comprised from 1 to 20%, particularly from 1 to 10%, in particular from 2 to 10% relative to the sum of all the monomer units of said copolyamide, comprises the remaining parts of a fatty acid dimer having the following formula (I):

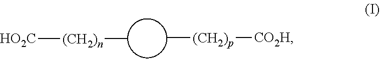

wherein:
n is comprised from 1 to 10, particularly 1 to 7,
p is comprised from 1 to 10, particularly 1 to 7,

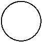

corresponds to a structure chosen from:

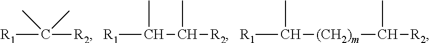

m being comprised from 1 to 5,
   wherein R₁ and R₂ represent, independently of each other, H or a C₁ to C₁₂ alkyl chain, particularly C₇ to C₁₁,
and

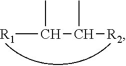

wherein R₁ and R₂ are cyclized to form a structure:
i) with a ring of type
cyclohexane:

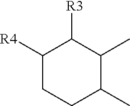

or phenyl:

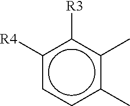

ii) with two rings of 1,2,3,4-tetrahydronaphthalene type

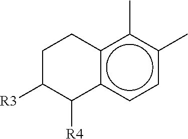

or of bicyclo[4.4.0]decane type:

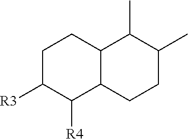

R₃ and R₄ being in the structures of one or two rings of C₁ to C₁₀ alkyl residues, particularly C₇ to C₉, or a mixture thereof,
   the total number of carbon atoms in the diacid having formula (I), the diamine having formula (II) and the amino acid having formula (III) being greater than or equal to 30, particularly greater than or equal to 36, particularly 36,
   and at least one of the other monomer units of said copolyamide is a monomer unit A chosen from a monomer unit obtained from a C₆ to C₁₂ amino acid, a monomer unit obtained from a C₆ to C₁₂ lactam, and a monomer unit having the formula (Ca aliphatic diamine).(Cb aliphatic diacid), with a representing the number of carbon atoms in the diamine and b representing the number of carbon atoms in the diacid, a and b each being inclusively between 4 and 36, in particular between 4 and 22.

In an advantageous embodiment, the present invention relates to the use of a composition as defined above, wherein the minority monomer unit is a monomer unit X.diacid having formula (I), X being an aliphatic diamine.

In an advantageous embodiment, the present invention relates to the use of a composition as defined above, wherein

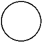

corresponds to

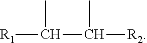

In an advantageous embodiment, the present invention relates to the use of a composition as defined above, wherein the polymerized fatty acid comprises a fatty acid dimer in proportions of at least 75% by weight, in particular of at least 92% by weight, particularly of at least 95% by weight.

In an advantageous embodiment, the present invention relates to the use of a composition as defined above, wherein:
said polyamide is constituted of a semi-crystalline copolyamide, and
said minority monomer unit, in molar proportion in the semi-crystalline copolyamide comprised from 1 to 20%, particularly from 1 to 10%, in particular from 2 to 10% relative to the sum of all the monomer units of said copolyamide, comprises the remaining parts of a fatty acid dimer, in a proportion of at least 75% by weight, in particular of at least 92% by weight, particularly of at least 95% by weight, having the following formula (I):

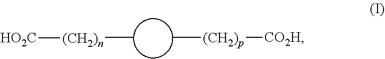

wherein:
n is comprised from 1 to 10, particularly 1 to 7,
p is comprised from 1 to 10, particularly 1 to 7,

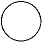

corresponds to a structure chosen from:

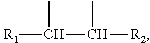

wherein R₁ and R₂ represent, independently of each other, H or a C₁ to C₁₂ alkyl chain, particularly C₇ to C₁₁,
   the total number of carbon atoms in the diacid having formula (I), the diamine having formula (II) and the amino acid having formula (III) being greater than or equal to 30, particularly greater than or equal to 36, particularly 36, and at least one of the other monomer units of said copolyamide is a monomer unit A chosen from a monomer unit obtained from a C₆ to C₁₂ amino acid, a monomer unit obtained from a C₆ to C₁₂ lactam, and a monomer unit having the formula (Ca aliphatic diamine).(Cb aliphatic diacid), with a representing the number of carbon atoms in the diamine and b representing the number of carbon atoms in the diacid, a and b each being inclusively between 4 and 36, in particular between 4 and 22.

Advantageously, the present invention relates to the use of a composition as defined above, wherein the number of carbons of the diamine X is greater than 8, particularly is equal to 10.

Advantageously, the monomer unit A is a monomer unit obtained from the polycondensation of a lactam or an amino acid, particularly chosen from PA11 and PA12.

Advantageously, the present invention relates to the use of a composition as defined above, wherein the number of carbons of the diamine X is greater than 8, particularly is equal to 10 and the monomer unit A is a monomer unit obtained from the polycondensation of a lactam or an amino acid, particularly chosen from PA11 and PA12.

Advantageously, the present invention relates to the use of a composition as defined above, wherein the monomer unit A is a monomer unit obtained from the polycondensation of a Ca aliphatic diamine and a Cb aliphatic dicarboxylic acid, particularly the monomer unit Ca+Cb≥15, in particular ≥19.

In the units A=CaCb and/or X.diacid having formula (I), independently of each other, up to 30 mol %, relative to the total quantity of carboxylic diacids, the diacid Cb and/or diacid having formula (I) may be replaced by other aromatic, aliphatic or cycloaliphatic carboxylic diacids comprising 6 to 36 carbon atoms, particularly 6 to 14 carbon atoms, and,

in the A=CaCb and/or X.diacid units having formula (I), independently of each other, up to 30 mol % of Ca and/or if applicable X, relative to the total quantity of the diamines, can be replaced by other diamines comprising from 4 to 36 carbon atoms, particularly 6 to 12 carbon atoms, and

in the copolyamide, not more than 30 mol %, relative to the total quantity of the monomers, can be formed by lactams or aminocarboxylic acids, and

provided that the sum of the monomers that replace the diacid having formula (I) the diacid Cb, the diamine Ca and X does not exceed a concentration of 30 mol % relative to the total quantity of the monomers used in the copolyamide and provided that none of the units Ca, Cb, X and diacid having formula (I) are totally substituted.

Advantageously, the present invention relates to the use of a composition as defined above, wherein the number of carbons of the diamine X is greater than 8, particularly is equal to 10 and the monomer unit A is a monomer unit obtained from the polycondensation of a Ca aliphatic diamine and a Cb aliphatic dicarboxylic acid, particularly the monomer unit Ca+Cb≥15, in particular ≥19.

Advantageously, the monomer unit A is chosen from PA614, PA618, PA1010, PA1012, PA1014, PA1018, PA1210, PA1212, PA1214, PA1218.

In an advantageous embodiment, the present invention relates to the use of a composition as defined above, wherein said composition comprises a polyamide chosen from an aliphatic, cycloaliphatic and aromatic polyamide, and said at least one semi-crystalline polyamide.

Advantageously, said aliphatic or cycloaliphatic or aromatic polyamide is in a proportion by weight of 0.1 to 90%, in particular from 0.1 to 80%, particularly from 0.1% to 50%.

Advantageously, said polyamide is an aliphatic or cycloaliphatic polyamide identical to monomer unit A of said semi-crystalline polyamide.

Advantageously, the composition comprises two polyamides of which one is the semi-crystalline copolyamide comprising at least one minority monomer unit.

Advantageously, the composition comprises two polyamides of which one is an aliphatic homopolyamide and the other is the semi-crystalline copolyamide comprising at least one minority monomer unit, particularly said aliphatic homopolyamide being in a proportion by weight from 0.1 to 90%, in particular from 0.1 to 80%.

In an advantageous embodiment, the present invention relates to the use of a composition as defined above, wherein the composition further comprises at least one polyolefin, particularly a functionalized polyolefin.

The polyolefin may be functionalized or non-functionalized, advantageously functionalized, or be a mixture of at least one functionalized and/or at least one non-functionalized polyolefin, particularly a mixture of at least one functionalized and at least one non-functionalized polyolefin.

Polyolefin is understood to mean a polymer comprising olefin monomer units such as, for example, ethylene, propylene, butene, octene monomer units or any other alpha olefin.

As examples, mention may be made of:
polyethylenes such as LDPE, HDPE, LLDPE or VLDPE, polypropylene or also metallocene polyethylenes;
ethylene copolymers such as ethylene/propylene copolymers, ethylene/propylene/diene terpolymers; and
ethylene copolymers with at least one product chosen from the salts or esters of unsaturated carboxylic acids and vinyl esters of saturated carboxylic acids;
acrylonitrile and butadiene copolymers such as NBR.

In a particularly advantageous version of the invention, the polyolefin is an elastomer ethylene copolymer.

Such an elastomer ethylene copolymer is a compound obtained from at least two distinct monomers including at least one ethylene monomer.

Preferably, this ethylene elastomer copolymer is chosen from an ethylene/propylene copolymer (EPR), an ethylene/butylene copolymer, an ethylene/octene copolymer and an ethylene/alkyl (meth)acrylate copolymer.

The ethylene/propylene copolymer (EPR) is a well-known elastomer copolymer, obtained from ethylene and propylene monomers. EPR or EPM, is in particular described in the work Ullmann's Encyclopedia of Industrial Chemistry, 5th edition, Vol A 23, pages 282 to 288, the content being incorporated in the present application.

The ethylene/butylene copolymer is obtained from ethylene and 1-butene monomers.

The ethylene/alkyl (meth)acrylate copolymer is obtained by the free-radical polymerization of ethylene and alkyl (meth)acrylate. The alkyl meth(acrylate) is preferably chosen from methyl (meth)acrylate, ethyl acrylate, n-butyl acrylate, isobutyl acrylate, octyl acrylate and 2-ethylhexyl acrylate.

The polyolefin used in the scope of the present invention can be functionalized in the sense that it comprises at least one epoxy, anhydride or acid function, this function being introduced by grafting or by copolymerization.

The functionalized polyolefin may in particular be chosen from functionalized ethylene/alpha olefin copolymers, and functionalized ethylene/alkyl (meth)acrylate copolymers.

The functionalized polyolefin may also be chosen from:
copolymers of ethylene, an unsaturated epoxide and optionally an ester or an unsaturated carboxylic acid or a vinyl ester of a saturated carboxylic acid. These are, for example, ethylene/vinyl acetate/glycidyl (meth)acrylate copolymers or ethylene/alkyl (meth)acrylate/glycidyl (meth)acrylate copolymers,
copolymers of ethylene, an unsaturated carboxylic acid anhydride and/or an unsaturated carboxylic acid that can be partially neutralized by a metal (Zn) or an alkali metal (Li) and optionally by an unsaturated carboxylic acid ester or by a vinyl ester of a saturated carboxylic acid. These are, for example, ethylene/vinyl acetate/maleic anhydride copolymers, ethylene/alkyl (meth)acrylate/maleic anhydride copolymers or also ethylene/Zn or Li (meth)acrylate/maleic anhydride copolymers.

The density of the functionalized polyolefin may advantageously be comprised between 0.86 and 0.965.

In an advantageous manner, the polyolefin is functionalized by a carboxylic acid anhydride.

More preferentially, the functional polyolefin is chosen from an ethylene/propylene copolymer (EPR) grafted with maleic anhydride, an ethylene/butylene copolymer grafted with maleic anhydride, an ethylene/octene copolymer grafted with maleic anhydride and an ethylene/alkyl (meth)acrylate copolymer comprising a maleic anhydride function, a styrene/ethylene-butene/styrene block copolymer (SEBS).

As an example of ethylene/alkyl (meth)acrylate copolymer comprising a maleic anhydride function, mention may be made of terpolymers of ethylene, alkyl acrylate and maleic anhydride, in particular sold by the Applicant under the trade name Lotader®.

As an example of styrene/ethylene-butene/styrene block copolymer (SEBS), mention may be made of Kratons®, in particular Kraton® FG 1901 sold by Kraton Polymers International.

The polyolefin is present from 0.1 to 50% by weight, advantageously from 12 to 40% advantageously from 10 to 30%.

In another advantageous embodiment, said polyolefin is present in a proportion by mass of 12 to 40% in said composition.

In an advantageous embodiment, said composition is devoid of plasticizer.

In another advantageous embodiment, said composition is devoid of plasticizer and said polyolefin is present in a proportion by mass of 12 to 40% in said composition.

In an advantageous embodiment, the present invention relates to the use of a composition as defined above, wherein the composition further comprises at least one plasticizer.

The plasticizer is chosen from benzene sulfonamide derivatives, such as n-butyl benzene sulfonamide (BBSA); ethyl toluene sulfonamide or N-cyclohexyl toluene sulfonamide; esters of hydroxy-benzoic acids, such as ethyl-2-hexyl parahydroxybenzoate and decyl-2-hexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

The particularly preferred plasticizer is n-butyl benzene sulfonamide (BBSA).

The plasticizer may be introduced into the polyamide during polycondensation or later.

The plasticizer used in the composition is in a proportion by mass of 3 to 10%, particularly from 4 to 7%.

In another advantageous embodiment, said plasticizer is in a proportion by mass of 3 to 10%, in particular from 4 to 7% and said polyolefin is present in a proportion by mass from 12 to 40% in said composition.

In an advantageous embodiment, the present invention relates to the use of a composition as defined above, wherein the composition further comprises at least one additive.

The additive is chosen among a catalyst, an antioxidant, a heat-stabilizer, particularly Naugard® 445, a UV stabilizer, a light stabilizer, a lubricant, a filler, a flame-retardant agent, a nucleating agent, a chain-lengthener and a colorant.

The term “catalyst” denotes a polycondensation catalyst such as a mineral or organic acid.

Advantageously, the proportion by weight of catalyst is comprised from around 50 ppm to around 5000 ppm, particularly from around 100 to around 3000 ppm relative to the total weight of the composition.

Advantageously, the catalyst is chosen from phosphoric acid (H3PO4), phosphorous acid (H3PO3), hypophosphorous acid (H3PO2), or a mixture thereof.

The antioxidant may in particular be an antioxidant containing a copper complex from 0.05 to 5% by weight, preferably from 0.05 to 1% by weight preferably from 0.1 to 1%.

The expression copper complex denotes in particular a complex between a monovalent or divalent copper salt with an organic or inorganic acid and an organic ligand.

Advantageously, the copper salt is chosen from cupric (Cu(II)) salts of hydrogen halides, cuprous (Cu(I)) salts of hydrogen halides and salts of aliphatic carboxylic acids.

Specifically, the copper salts are chosen from CuCl, CuBr, CuI, CuCN, CuCl2, Cu(OAc)2, cuprous stearate.

Copper complexes are in particular described in U.S. Pat. No. 3,505,285.

Said copper-based complex may further comprise a ligand selected from phosphines, in particular triphenylphosphines, mercaptobenzimidazole, EDTA, acetylacetonate, glycine, ethylene diamine, oxalate, diethylene diamine, triethylenetetramine, pyridine, diphosphone and dipyridyl or mixtures thereof, particularly triphenylphosphine and/or mercaptobenzimidazole.

Phosphines denote alkylphosphines, such as tributylphosphine or arylphosphines such as triphenylphosphine (TPP).

Advantageously, said ligand is triphenylphosphine.

Examples of complexes and how to prepare them are described in patent CA 02347258.

Advantageously, the quantity of copper in the composition of the invention is comprised from 10 ppm to 1000 ppm by weight, in particular from 20 ppm to 70 ppm, particularly from 50 to 150 ppm relative to the total weight of the composition.

In an advantageous embodiment, the present invention relates to the use of a composition as defined above, characterized in that said copper-based complex further comprises a halogenated organic compound.

The halogenated organic compound can be any halogenated organic compound.

Advantageously, said halogenated organic compound is a bromine-based compound and/or an aromatic compound.

Advantageously, said aromatic compound is in particular chosen from decabromediphenyl, decabromodiphenyl ether, bromostyrene or chlorostyrene oligomers, polydibromostyrene, tetrabromobisphenyl-A, tetrabisphenyl-A derivatives, such as epoxy derivatives, and chlorodimethanedibenzo(a,e)cyclooctene derivatives and mixtures thereof.

Advantageously, said halogenated organic compound is a bromine-based compound.

Said halogenated organic compound is added to the composition in a proportion of 50 to 30,000 ppm by weight of halogen relative to the total weight of the composition, in particular from 100 to 10,000 particularly from 500 to 1500 ppm.

Advantageously, the copper:halogen molar ratio is comprised from 1:1 to 1:3000, in particular from 1:2 to 1:100.

Particularly, said ratio is comprised from 1:1.5 to 1:15.

Advantageously, the antioxidant containing a copper complex is chosen from a Bruggolen® H3386, a Bruggolen® H3376, a Bruggolen® H3344, a Bruggolen® H3350, particularly a Bruggolen® H3386.

It is also possible to use chain limiters as additives.

Examples of appropriate chain limiters are monoamines, monocarboxylic acids, diamines, triamines, dicarboxylic acids, tricarboxylic acids, tetraamines, tetracarboxylic acids and, oligoamines or oligocarboxylic acids having respectively in each case 5 to 8 amino or carboxy groups and particularly dicarboxylic acids, tricarboxylic acids or a mixture of dicarboxylic and tricarboxylic acids. As an example, it is possible to use dodecanedicarboxylic acid in the form of a dicarboxylic acid and trimellitic acid as a tricarboxylic acid.

Preferably said chain limiter will be different from a monofunctional chain limiter.

Preferably, the additives of the polyamide of the composition of the invention are in a quantity of 0 to 10%, particularly from 1 to 10%, by weight relative to the total weight of the composition.

In an advantageous embodiment, the present invention relates to the use of a composition as defined above, wherein the composition comprises by weight:
50 to 99.9%, advantageously 60 to 99.9%, particularly 70 to 99.9%, in particular from 70 to 88% by weight of said semi-crystalline copolyamide comprising optionally from 0 to 70% by weight of another polyamide,
0.1 to 50% by weight, advantageously from 12 to 40%, particularly from 12 to 30% by weight, of a polyolefin comprising an epoxy, anhydride or acid function, introduced by grafting or by copolymerization, and
0 to 10%, in particular from 3 to 10% by weight, advantageously from 4 to 7% by weight, of a plasticizer,
0 to 10%, by weight, of an additive, particularly from 1 to 10%,
the sum of the different constituents of the composition being equal to 100%.
All the possible combinations of ranges of proportions of said semi-crystalline copolyamide, of said polyolefin, of said plasticizer and of said additive are disclosed as such in the present description and therefore form part of the present description.
It is clearly obvious that when the sum of the various constituents of the composition leads to a value greater than 100%, the person skilled in the art will then vary one of the constituents, in particular the proportion of said semi-crystalline copolyamide to obtain 100%.

The composition used in the scope of the present invention is prepared by mixing, when melted, the various constituents in any mixing device, and preferably an extruder.

The composition is most commonly recovered in granule form.

According to another aspect, the present invention relates to a pipe, particularly a flexible pipe, intended to transport a cooling liquid, comprising at least one sealing layer (1) obtained from a composition as defined above.

The protective layer may be a coat of metallic or rubber fibers.

All the characteristics defined above in the paragraph “Use” are valid for the pipe comprising the composition of the invention.

According to another aspect, the present invention relates to a composition comprising by weight:
57 to 85%, preferably 70 to 85% by weight of a semi-crystalline copolyamide as defined above, optionally comprising from 0 to 70% by weight of another polyamide relative to said semi-crystalline copolyamide,
from 12 to 40% by weight, preferably from 12 to 30% of a polyolefin comprising an epoxy, anhydride or acid function, introduced by grafting or by copolymerization,
from 3 to 10% by weight, advantageously from 4 to 7% by weight, of a plasticizer, and
from 0 to 10%, by weight, of an additive, particularly from 1 to 10%, %, the sum of the different constituents of the composition being equal to 100%.
All the possible combinations of ranges of proportions of said semi-crystalline copolyamide, of said polyolefin, of said plasticizer and of said additive are disclosed as such in the present description.
It is clearly obvious that when the sum of the various constituents of the composition lead to a value greater than 100%, the person skilled in the art will then vary one of the constituents, in particular the proportion of said semi-crystalline copolyamide to obtain 100%.

Advantageously, said other polyamide is an aliphatic polyamide, particularly PA11 or PA12.

Advantageously, said copolyamide of the composition defined above comprises at least one minority monomer unit from the polycondensation:
of at least one diamine with at least one polymerized fatty acid, particularly a fatty acid dimer, or
of at least one diamine dimer with at least one dicarboxylic acid, or
of at least one amino acid dimer,

particularly coming from the polycondensation:
of at least one diamine with at least one polymerized fatty acid, particularly a fatty acid dimer, or
of at least one diamine dimer with at least one dicarboxylic acid, or mixtures thereof.

Advantageously, said minority monomer unit of said copolyamide of the composition defined above is a monomer unit X.diacid having formula (I), X being an aliphatic diamine.

The present invention will now be illustrated by examples of various compositions whose use is the subject of the present invention and by various structures of flexible pipes, also conforming to the subject of the present invention.

### DESCRIPTION OF THE FIGURES

FIG. 1 shows the hydrolysis at 130° C. pH4 of molded parts obtained from the different compositions formulated in Table III.

The residual lengthening is about 2 times as high at equal aging. The lifetime for reaching a break on lengthening of 50% (usual criterion) is clearly higher.

The extruded part obtained with the formulated composition of the invention with Pripol 1009 therefore has very obviously improved resistance to hydrolysis compared with a part obtained with a formulation containing PA11.

X-axis: aging duration in hours

Y-axis: Break on lengthening (%)

Upper curve: FI2

Middle curve: FI1

Lower curve: FC1

### EXAMPLES

### 1. Preparation of a Polymer of the Composition According to the Invention

The following compositions were prepared

TABLE I

| Polyamide and | C1 | I1 | |
|---|---|---|---|
| Molar composition | PA11 | PA11/10.Pripol 1009 19/1 | unit |
| Terephthalic acid | — | — | kg |
| 11-Undecanoic | 29 | 27.62 | kg |
| amino acid | | | |
| Decanediamine | — | 1.26 | kg |
| Sebacic acid | — | — | kg |
| Pripol 1009 | — | 4.12 | kg |
| BisHMTA | — | — | kg |
| N-heptylamino-11- | — | — | kg |
| undecanoic acid | | | |
| Deionized water | 8 | 4 | kg |
| H₃PO₄ 85% | 20.4 | 23.3 | g |

The Pripol 1009 used has a hydroxyl index IOH=196 mg KOH/g, which gives an equivalent molar mass of 572.6 g/mol.

Pripol 1009 is constituted of: ≥98.5% of dimer, ≤1% of trimer, ≤1% of 1½ mer and ≤0.1% of monomer.

The synthesis conditions were as follows:

After charging, the 100 liter autoclave reactor is deoxygenated by sequences of nitrogen pressurization then release. The reactor's content is heated to 240° C. under autogenous pressure and with stirring then held for 1 h in these conditions. The reactor is then relaxed to a pressure of 0.2 bar relative in 2 hours then held for 30 minutes in these conditions. The polymer obtained is then unloaded from the reactor in the form of rods and then in the form of granules.

The polymers have the following characteristics:

TABLE II

| | C1 | I1 |
|---|---|---|
| Composition | PA11 | PA11/10.Pripol 1009 19/1 |
| Acidity (meq/g) | 0.05 | 0.056 |
| Basicity (meq/g) | 0.038 | 0.04 |
| Inherent viscosity | 1.45 | 1.41 |
| m-cresol (dL/g) | | |
| Tm (° C.) | 189 | 174 |
| Tc (° C.) | 155 | 145 |
| Enthalpy of | 60 | 48 |
| crystallization (J/g) | | |
| Tg (° C.) | 48 | 31 |

Inherent viscosity is measured in m-cresol according to ISO standard 307:2007 but while changing the solvent (use of m-cresol instead of sulfuric acid and the temperature being 20° C.).

The crystallization enthalpy of said polymer matrix is measured using differential scanning calorimetry (DSC) according to ISO standard 11357-3:2013. The heating and cooling rates are 20° C./min.

The Tm and Tc are measured by differential scanning calorimetry (DSC) according to ISO standard 11357-3:2013. The heating and cooling rates are 20° C./min.

The Tg is measured by differential scanning calorimetry (DSC) according to ISO standard 11357-2:2013. The heating and cooling rates are 20° C./min.

The Mn of the thermoplastic polymer is determined from the titration (assay) of the terminal functions according to a potentiometric method (direct assay of acids or bases)

### 2. Preparation of Formulated Compositions

The following formulations were prepared (Table III)

TABLE III

| | | Formulation | Formulation |
|---|---|---|---|
| | FC1 | Invention | Invention |
| | % by | FI1 % by | FI2 % by |
| reference | weight | weight | weight |
| C1 | 67.9 | | |
| I1 | | 67.9 | 82.9 |
| Lotader 4700 | 24 | 24 | |
| Lotader AX8900 | 4 | 4 | |
| Escor 5000 | 2 | 2 | |
| Orevac IM 800 | | | 15 |
| MM euthylen black | 0.9 | 0.9 | 0.9 |
| 6005 C4 | | | |
| ANOX ® NDB TL89 | 1.2 | 1.2 | 1.2 |

Escor® 5000: polyolefin (ethylene-functionalized maleic acrylic acid copolymer) sold by Exxon.

Orevac® IM800: polyolefin (ethylene-functionalized maleic anhydride copolymer) sold by Arkema.

Lotader 4700: ethylene, acrylic ester and maleic anhydride terpolymer sold by Arkema.

Lotader AX8900: ethylene, acrylic ester and glycidyl methacrylate terpolymer sold by Arkema MM euthylen black 6005 C4: master black mixture sold by BASF.

ANOX® NDB TL89: phenol phosphite organic stabilizer sold by Chemtura.

These experiments were conducted on the HAAKE 2-9 screw profile.

The compounding flow rate was 2.2 kg/hr for a screw rate of 300 rpm and a flat temperature profile at 270° C.

3. Hold Upon Cooling (Hydrolysis) at 130° C. of Molded Parts Obtained from the Compositions in Table III.

### 3.1 Preparation of Molded Parts

ISOR 527 1BA dumbbells

### 3.2 Hydrolysis Test Protocol

The dumbbells are placed in steel autoclaves.

Filling water Volvic 50% by weight and ethylene glycol (Havoline) 50% by weight, sealing closed and bubbling nitrogen for at least 3.5 hours.

Pressurized with CO₂ at 24 bars to obtain pH4.

Autoclaves installed in an oven at 130° C.

The dumbbells are sampled according to the plan defined.

With each sampling, the Volvic water and Havoline, inerting and pressurization are repeated.

5 dumbbells are sampled and subjected to a traction test at a speed of 50 mm/min. The lengthening is measured by an extensometer. The mean of the resulting break on lengthening determined is reported as a function of aging time.

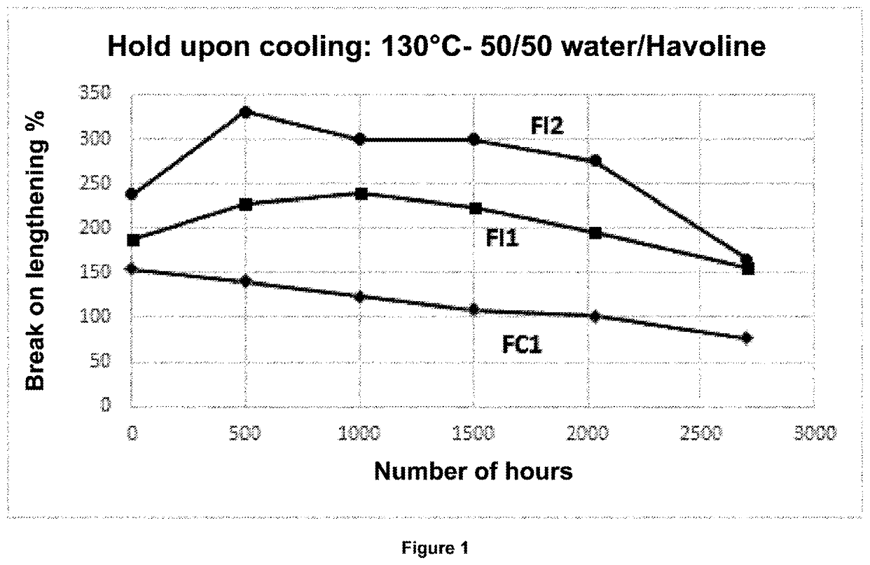

The results are shown in FIG. 1.

In these conditions, formulation FC1 resists for 2700 hours to have 50% of the initial lengthening.

Formulations FI1 and FI2 are still at 83 and 69% of the initial break on lengthening at 2700 hours.

For break on lengthening at the absolute break, formulation FC1 is at 77% whereas formulations FI1 and FI2 are at 156 and 165%.

1. A sealing layer in a pipe, wherein said sealing layer composition comprises at least one polyamide, said polyamide is a semi-crystalline copolyamide comprising at least one minority monomer unit coming from the polycondensation:
of at least one diamine with at least one polymerized fatty acid, or
of at least one diamine dimer with at least one dicarboxylic acid, or
of at least one amino acid dimer.

2. The sealing layer in a pipe according to claim 1, wherein said minority monomer unit comprises at least one of the following formulas:
either the residue of a fatty acid dimer having the following formula (I): 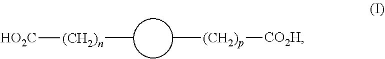
or the residue of a diamine dimer having the following formula (II): 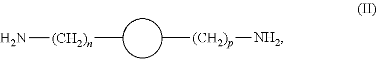
or the residue of an amino acid dimer having the following formula (III): 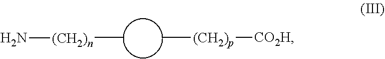
or a mixture thereof,
wherein, independently of each other:
n is comprised from 1 to 10,
p is comprised from 1 to 10, 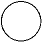
corresponds to a structure chosen from: 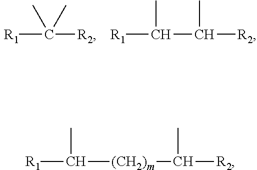
m being comprised from 1 to 5
wherein R₁ and R₂ represent, independently of each other, H or a C₁ to C₁₂ alkyl chain,
and 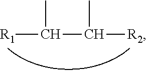
wherein R₁ and R₂ are cyclized to form a structure:
i) with a ring of type
cyclohexane 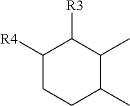
or phenyl: 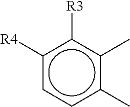
ii) with two rings of 1,2,3,4-tetrahydronaphthalene type 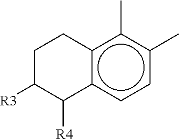
or of bicyclo[4.4.0]decane type: 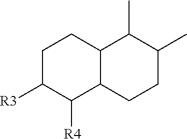
R₃ and R₄ being in the structures of one or two rings of C1 to C10 alkyl residues,
or a mixture thereof,
the total number of carbon atoms in the diacid having formula (I), the diamine having formula (II) and the amino acid having formula (III) being greater than or equal to 30.

3. The sealing layer in a pipe according to claim 1, wherein the pipe is a flexible pipe.

4. The sealing layer in a pipe according to claim 1, wherein the copolyamide is an aliphatic copolyamide.

5. The sealing layer in a pipe according to claim 1, wherein the viscosity in solution of said sealing layer composition, as determined according to ISO standard 307:2007 in m-cresol at a temperature of 20° C., is greater than 1.

6. The sealing layer in a pipe according to claim 1, wherein the Tm of the composition is greater than 170° C., as determined according to ISO standard 11357-3:2013 at a rate of 20 K/min in DSC.

7. The sealing layer in a pipe according to claim 1, wherein at least one of the other monomer units of said copolyamide is a monomer unit A selected from the group consisting of a monomer unit obtained from a C₆ to C₁₂ amino acid, a monomer unit obtained from a C₆ to C₁₂ lactam, and a monomer unit having the formula (aliphatic diamine Ca).(aliphatic diacid Cb), with a representing the number of carbon atoms in the diamine and b representing the number of carbon atoms in the diacid, a and b each being inclusively between 4 and 22.

8. The sealing layer in a pipe according to claim 1, wherein the molar proportion of said at least minority monomer unit in the semi-crystalline copolyamide is from 1 to 20%, relative to the sum of all the monomer units of said copolyamide.

9. The sealing layer in a pipe according to claim 2, wherein said minority monomer unit is a monomer unit X.diacid having formula (I), X being an aliphatic diamine.

10. The sealing layer in a pipe according to claim 9, wherein 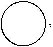
as defined in formulas (I), (II) and (III) corresponds to

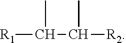

11. The sealing layer in a pipe according to claim 9, wherein the polymerized fatty acid comprises a fatty acid dimer in proportions of at least 75% by weight.

12. The sealing layer in a pipe according to claim 9, wherein the number of carbons in diamine X is greater than 8.

13. The sealing layer in a pipe according to claim 7, wherein the monomer unit A is a monomer unit obtained from the polycondensation of a lactam or an amino acid.

14. The sealing layer in a pipe according to claim 7, wherein the monomer unit A is a monomer unit obtained from the polycondensation of a Ca aliphatic diamine and a Cb aliphatic dicarboxylic acid.

15. The sealing layer in a pipe according to claim 14, wherein the monomer unit A is selected from the group consisting of PA614, PA618, PA1010, PA1012, PA1014, PA1018, PA1210, PA1212, PA1214, and PA1218.

16. The sealing layer in a pipe according to claim 7, wherein the composition comprises a polyamide selected from the group consisting of an aliphatic, cycloaliphatic and aromatic polyamide, and said at least one semi-crystalline polyamide.

17. The sealing layer in a pipe according to claim 16, wherein said polyamide is an aliphatic or cycloaliphatic polyamide identical to monomer unit A of said semi-crystalline polyamide.

18. The sealing layer in a pipe according to claim 1, wherein the composition further comprises at least one additive selected from the group consisting of a polyolefin, and a plasticizer, or a mixture thereof.

19. (canceled)

20. The sealing layer in a pipe according to claim 1, wherein the composition further comprises at least one additive.

21. The sealing layer in a pipe according to claim 1, wherein the composition comprises by weight:
50 to 99.9% by weight of said semi-crystalline copolyamide optionally comprising from 0 to 70% by weight of another polyamide relative to said semi-crystalline copolyamide,
0.1 to 50% by weight of a polyolefin comprising an epoxy, anhydride or acid function, introduced by grafting or by copolymerization, and
0 to 10% by weight, of a plasticizer,
0 to 10%, by weight, of an additive,
the sum of the different constituents of the composition being equal to 100%.

22. A pipe, for transporting a cooling liquid comprising at least one sealing layer (1) obtained from a composition as defined according to claim 1.

23. A composition comprising by weight:
57 to 85% of a semi-crystalline copolyamide as defined in claim 1, optionally comprising from 0 to 70% by weight of another polyamide,
from 12 to 40% by weight of a polyolefin comprising an epoxy, anhydride or acid function, introduced by grafting or by copolymerization,
from 3 to 10% by weight by weight, of a plasticizer, and
from 0 to 10%, by weight,
the sum of the different constituents of the composition being equal to 100%.

24. The composition according to claim 23, wherein said other polyamide is selected from the group consisting of an aliphatic polyamide, PA11, and PA12.

25. The composition according to claim 23, wherein said copolyamide is a semi-crystalline copolyamide comprising at least one minority monomer unit having at least one of the following formulas:
either the residue of a fatty acid dimer having the following formula (I): 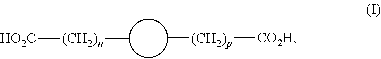
or the residue of a diamine dimer having the following formula (II): 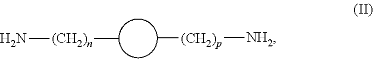
or the residue of an amino acid dimer having the following formula (III): 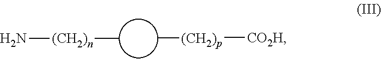
or a mixture thereof,
wherein, independently of each other:
n is comprised from 1 to 10,
p is comprised from 1 to 10, 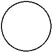
corresponds to a structure chosen from: 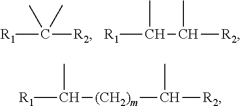
m being comprised from 1 to 5
wherein R₁ and R₂ represent, independently of each other, H or a C₁ to C₁₂ alkyl chain,
and 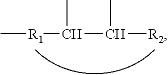
wherein R₁ and R₂ are cyclized to form a structure:
i) with a ring of type
cyclohexane: 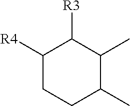
or phenyl: 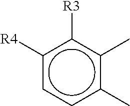
ii) with two rings of 1,2,3,4-tetrahydronaphthalene type 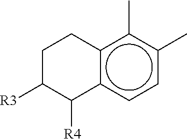
or of bicyclo[4.4.0]decane type: 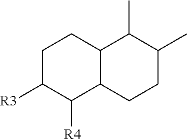
R₃ and R₄ being in the structures of one or two rings of C1 to C10 alkyl residues,
or a mixture thereof,
the total number of carbon atoms in the diacid having formula (I), the diamine having formula (II) and the amino acid having formula (III) being greater than or equal to 30.

26. The composition according to claim 23, wherein said semi-crystalline copolyamide comprises a monomer unit X.diacid having formula (I), X being an aliphatic diamine.

27. The sealing layer in a pipe according to claim 1, wherein said sealing layer comprises at least one polyamide, wherein said polyamide is a semi-crystalline copolyamide comprising at least one minority monomer unit coming from the polycondensation:
of at least one diamine with at least one polymerized fatty acid, particularly a fatty acid dimer, or
of at least one diamine dimer with at least one dicarboxylic acid, or mixtures thereof.
